(19) United States
(12) Patent Application Publication
(10) Pub. No.: US 2025/0231995 A1
(43) Pub. Date: Jul. 17, 2025

(54) SYSTEM FOR ORGANIZING AND RETRIEVING FILES WITHIN A WEB BROWSER APPLICATION

(71) Applicant: Malcolm Mason Rodriguez, New York, NY (US)

(72) Inventor: Malcolm Mason Rodriguez, New York, NY (US)

(21) Appl. No.: 18/411,017

(22) Filed: Jan. 11, 2024

(51) Int. Cl. G06F 16/955; G06F 16/957

(52) U.S. Cl. CPC G06F 16/9562; G06F 16/957

(57) ABSTRACT

The present invention extends the browser's basic functionality and improves the experience around managing browser tabs and bookmarks, permitting a user to organize web resources in collections according to a specific task or activity. Each collection includes a set of tabs and a set of bookmarks, some of which may be favorited and displayed within the user interface when the associated tab group is open and active. Since users are reluctant to create tab groups and bookmark folders, the present invention automatically groups related tabs and creates a corresponding bookmark folder for each tab group. By integrating tab groups and bookmarks in this way, the user is afforded a convenient and intuitive means of saving and retrieving bookmarks.

### CROSS-REFERENCE TO RELATED APPLICATIONS

This application claims the benefit of provisional patent application Ser. No. 63/479,405, filed 2023 Jan. 11 by the present inventor.

### FEDERALLY SPONSORED RESEARCH

Not applicable.

### SEQUENCE LISTING

Not applicable.

### BACKGROUND

The web has become an integral part of everyday information seeking since its creation some thirty years ago. While the initial use of the web was confined to the exploration of curated catalogs of web resources such as Yahoo's web directory, today's web users engage in more complex information seeking tasks and workflows, where multiple resources are consulted in parallel. This change in user behavior has necessitated the introduction of tabbed interfaces that permit the user to quickly switch between web resources without having to navigate to multiple browser windows.

Tabbed browser interfaces typically present tabs in a horizontal row with finite screen space. As the number of open tabs increases the labels for each tab shrink until the title is completely obscured, making it difficult to identify any particular tab. This problem of tab overload can be brought on and exacerbated by a user's attempt to manage multiple information tasks within a single browser window.

To alleviate the problem, mainstream browsers have introduced a tab grouping feature to help users manage multiple information tasks and workflows within the same window. Tab groups are also collapsable, permitting users to save space along the tab bar. Despite the advantages of tab groups, the feature has enjoyed limited use, owing to the effort required to create and organize them. Additionally, tab groups suffer from some of the same problems that one finds with tabs. A user can create more tab groups than can be efficiently managed within the limited space of the tab bar. Tab groups are also not persistent. Consequently users may hoard tab groups in the same way that they used to hoard single tabs.

An alternative approach to managing web resources is to save them as bookmarks, but just like tab groups this feature is underutilized due to the effort required to create and organize bookmark folders. Bookmarks also do not have the visual prominence of tabs. Often users rely upon open tabs as reminders to perform an associated task. Bookmarks that are not saved along the bookmark bar are often not retrieved. Once out of sight they consequently go out of mind.

There are also solutions to managing tabs, bookmarks and browsing sessions through the use of browser extensions, programs that use the application programming interface of the browser to create new functionality and interfaces that are not present by default. Most of the users in need of better tab and bookmark management also forgo the use of these extensions owing to the cost of these services and to the complexity of their interfaces, which require users to learn and adopt new mental models for interacting with web resources.

### SUMMARY

The present invention extends the web browser's basic functionality and improves the experience around managing browser tabs and bookmarks, permitting the user to organize web resources in collections according to a specific task or activity. Each collection includes a set of tabs and a set of bookmarks, some of which may be favorited and displayed within the user interface when the associated tab group is open and active. Since users are reluctant to create tab groups themselves the present invention automatically groups related tabs and names the resulting tab group. Likewise, since users are reluctant to save bookmarks due to the effort required to create or select an appropriate bookmarking location the present invention automatically creates and designates a bookmarking location for each tab group, permitting the user to save any tab or link within the group with a single action. By making bookmarking more convenient, the invention reduces the need to keep open tabs with content that may be useful but not presently relevant, thereby conserving space along the tab bar. The present invention additionally permits the user to retrieve collections that have been closed, restoring the collection's last display state, including its tab group, active tab, and favorite bookmarks.

### DETAILED DESCRIPTION

### Brief Description of Drawings

FIG. 1 illustrates an example operating environment for the present invention.

FIG. 2 illustrates an example service worker contained within the operating environment and used to execute processes of the present invention.

FIG. 3 illustrates an example of a conventional tabbed browser window.

FIG. 4 illustrates a conceptual model of a browsing context and an example browser window that displays an active browsing context.

FIG. 5 includes flowcharts of example processes for creating and changing the state of a browsing context.

FIG. 6 illustrates an example of automatic tab grouping.

FIG. 7 includes a flow chart of example processes for automatically grouping tabs and creating a browsing context.

FIG. 8 illustrates an example of manually grouping tabs with a single action.

FIG. 9 illustrates examples of activating and deactivating a browsing context.

FIG. 10 includes flowcharts for example processes for activating and deactivating a browsing context.

FIG. 11 illustrates an example of bookmarking a tab within an active browsing context.

FIG. 12 includes flowcharts of example processes for saving and retrieving a temporary bookmark.

FIG. 13 includes a flowchart for an example process for updating the set of favorite bookmarks associated with a particular browsing context.

FIG. 14 illustrates an example of moving a tab to a browsing context with an omnibox input.

FIG. 15 includes a flowchart of an example process for moving or saving an active tab to a tab group, bookmark collection and/or browsing context.

FIG. 16 illustrates an example of retrieving a browsing context with an omnibox input

FIG. 17 includes a flowchart of an example process for retrieving a bookmark folder or browsing context with an omnibox input.

FIG. 18 includes flowcharts of example processes for restoring or creating a browsing context from bookmarks.

FIG. 19 includes a flowchart of an example process for closing multiple tab groups and browsing contexts with a single action.

FIG. 20 includes a data model for a browsing context's data.

### OPERATING ENVIRONMENT

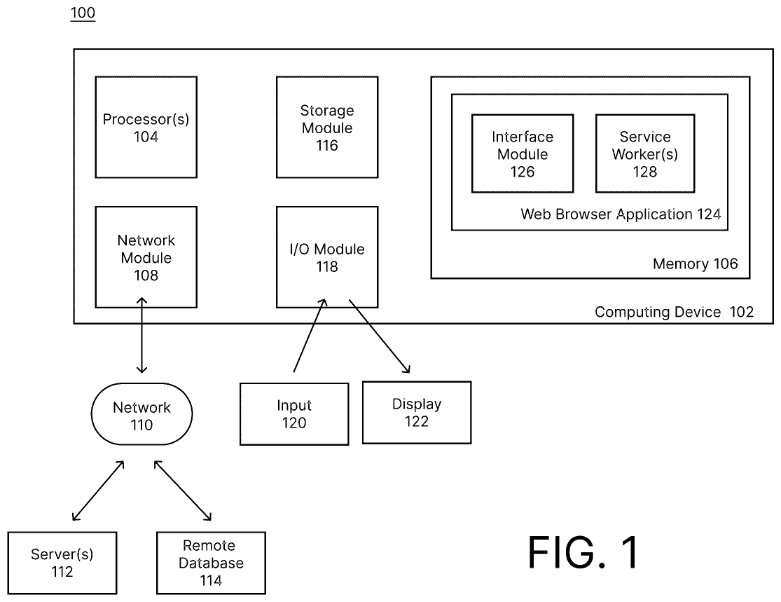

FIG. 1 illustrates an example operating environment 100 in which various techniques described can be used in accordance with one or more embodiments. The operating environment includes a computing device 102 capable of connecting to remote server(s) 112 from which to retrieve web resources and a remote database 114 with which to save and retrieve application data. The computing device 102 connects to these remote components over a network 110 such as the Internet with the connection and communication being coordinated by a network module 108.

Computing device 102 can be a variety of different types of devices, such as a physical device or a virtual device. For example, computing device 102 can be a physical device such as a desktop computer, a server computer, a laptop or netbook computer, a mobile device, an entertainment device, a television, a virtual reality headset, and so forth.

Computing device 102 includes a processor 104 and memory 106. Memory 106 may contain instructions or applications, such as the web browser application 124, which when executed by the processor 104 causes the computing device to perform elements of the present invention. The computing device additionally includes an I/O module 118 used to connect and communicate with external devices for input 120 such as a keyboard and mouse, and display 122 such as computer monitor, or a device that combines both functions such as a touch screen display.

The web browser application 124 includes a user interface module 126 that permits a user to open multiple tabbed browser windows and interact with the content and applications of web resources retrieved from the World Wide Web. The web browser application also includes service worker(s) 128 which listens for user actions within the user interface 126 and responds to those actions by updating the elements displayed in one or more browser windows, and storing data to the local storage module 116 or remote database 114. The processes described herein may be executed by the service worker or the instructions for said processes may be implemented in the native code of the computing device's operating system or encoded into the processor itself. The example of the service worker is used to illustrate a simple event driven architecture responsive to user actions.

### Service Worker

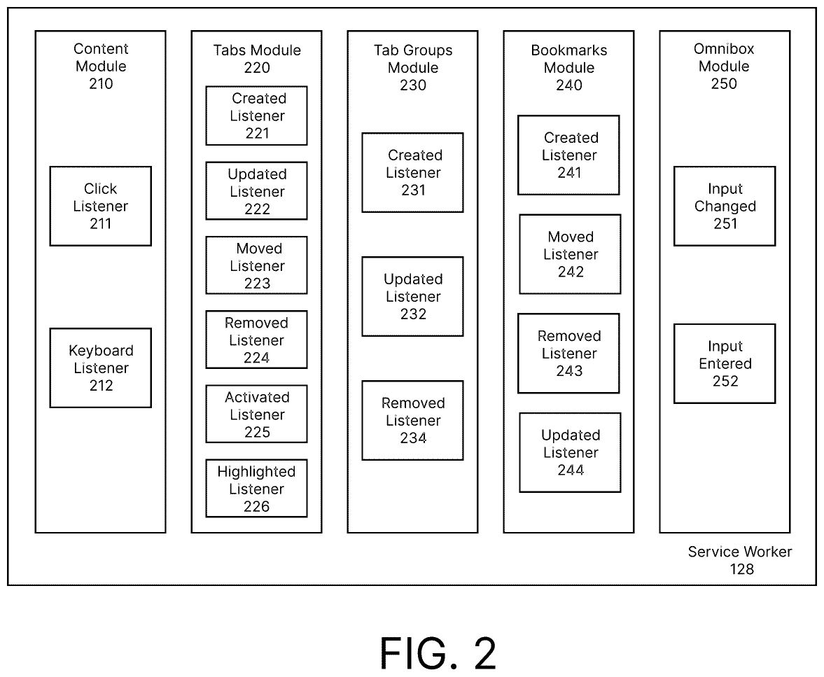

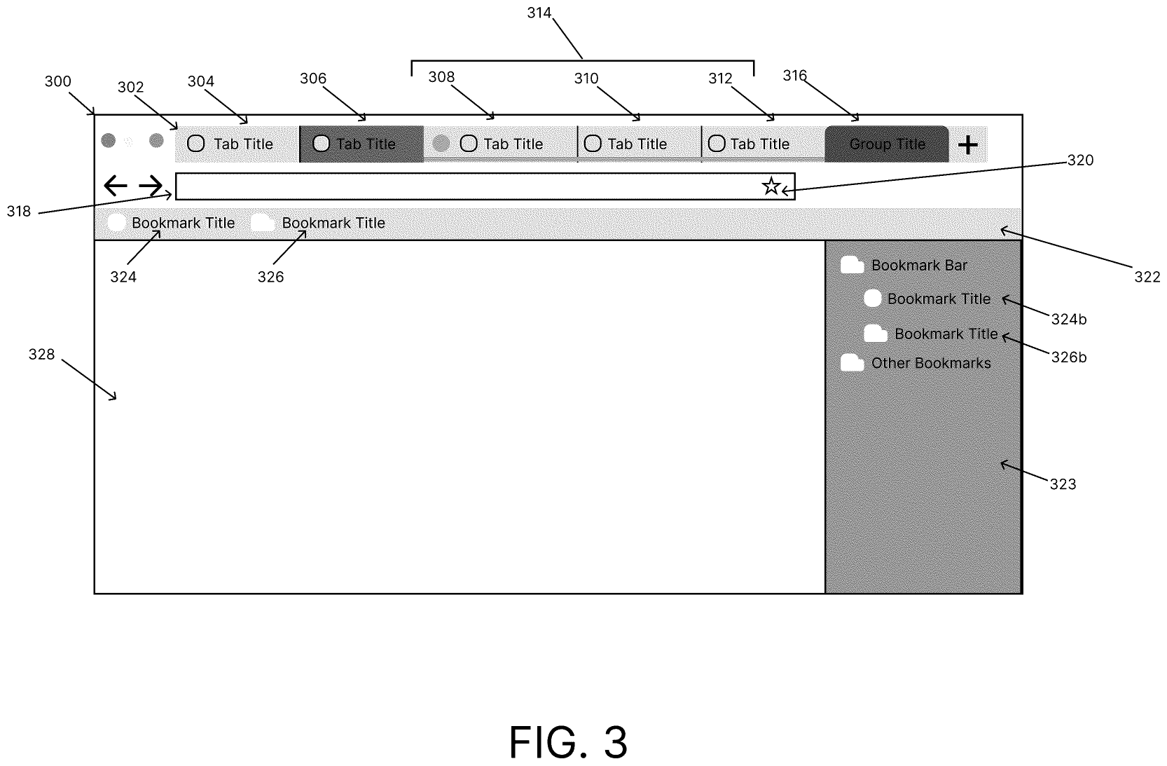

FIG. 2 illustrates modules in the service worker 128 that listen and respond to user actions and inputs from the user interface module 126. The service worker in the present example includes five modules, a content module 210, tab module 220, a tab group module 230, a bookmark module 240, and an omnibox module 250. Each module corresponds to a component of the browser window as depicted in FIG. 3.

The content module, which receives signals from the user interface when the user interacts with the web page of the active tab in the content display area 314, includes a click listener 211 for when the user clicks any element within the active tab's web page, as well as a keyboard listener 212 for when the user holds down or releases a keyboard key.

The tab module includes listeners for when a tab such as 304, 306, 308, 310, or 312 is created 221, updated 222, moved 223, removed 224, activated 225, and highlighted 226.

The tab group module includes listeners for when a tab group such as 314 or 316 is created 231, updated 232, and removed 234.

The bookmark module includes a listener for when a bookmark or bookmark folder such as 324 and 326 is created 241, moved 242, removed 243 and updated 244 as when the title or URL of a given bookmark is changed.

Lastly, the omnibox module includes listeners for when a user input into the omnibox 318 is changed 251 or entered 252.

### Browser Window

The primary role of the web browser application 124 is to display and manage computer files stored on remote servers and retrieved via the Internet. Since files are usually not stored on the same computing device running the web browser application they must be loaded into memory when a user wishes to open and display selected files. FIG. 3 illustrates, in accordance with one or more embodiments, an example of a conventional browser window 300 used to display local and remote files as tabs. A tabs is a component of the browser that acts as a container for a given file to keep it in memory and run any executable code (e.g. JavaScript) it contains. The example browser window 300 includes a tab bar 302 with open tabs 304, 306, 308, 310, and 312, each of which includes a label with the title and icon of its associated file. A user can view the file corresponding to a given tab by selecting its label, thereby prompting the browser to display the corresponding file within the content display area 328 and display the files locator, such as local file path or universal resource locator (URL), within the address bar 318. The selected tab is referred to as the browser windows active tab. In the example browser window 300, tab 306 is the active tab and is visually distinguished by its darker shading.

If a user wishes to display and navigate to another file that is not currently loaded within the active tab or any of the other open tabs, the user may enter a file's locator into the address bar 318 to retrieve, load and display the file. The address bar serves multiple functions outside of retrieving files from their locators and displaying those locators to the user. Aside from inputting a file locator a user can input a search query into the text field. In response to the users query the browser application presents suggestions of files to open, with those suggestions being retrieved from the users bookmarks, browsing history, and the users preferred web search engine. The present invention goes beyond permitting the user to simply retrieve individual files to also permit users to search, retrieve and open collections of files as tab groups, and to run commands in the manner of traditional command line interfaces. As a result of all of this additional functionality, the address bar is also referred to as an omnibox.

The tab bar is a display area for managing temporary resources such as tabs and tab groups, which are sets of tabs and/or tab groups that are organized under a single heading with a visual indicator such as border color to illustrate their shared relation. In the example provided the tab bar 302 is displayed as a horizontal row that includes tab groups 314 and 316, where tab group 314 is expanded to show its associated tabs 308, 310, 312 and tab group 316 is collapsed so that its tabs are hidden from view. It should be noted that the tab bar may be displayed both horizontally and vertically, and that tab groups may be nested within tab groups in the same way that a computer file system's folders can be infinitely nested.

Within the omnibox is a bookmark button 320, which permits the user to save the active tab as a bookmark and open a bookmarking interface for updating the title and location of the bookmark. A bookmark is a saved reference to a file, which includes the file's title, URL, and icon when available. When the active tab has a corresponding bookmark, the bookmark button appears with a visual indication that an associated bookmark has been saved. Usually this visual indication is produced by presenting the bookmark icon as filled in when a bookmark is saved and unfilled when an associated bookmark does not exist.

Bookmarks can be displayed in two areas of the browser window, the bookmark bar 322, which is found under the omnibox, and the bookmark display area 323 which is shown beneath the bookmark bar and to the right of the content display area 328. The bookmark bar and bookmark display area can display both bookmarked files, such as 324 and 324b, as well as bookmark folders such as 326 and 326b. In the present example, the contents of the bookmark bar are displayed both within bookmark bar 322 and within the bookmark display area 323 since the bookmark bar is itself treated as a bookmark folder. The bookmark bar is used primarily for storing and displaying bookmarked websites that the user frequently visits. It may also be used to temporarily store and display bookmarks that users wish to get back to but believe they are unlikely to return to if the bookmark is stored in a bookmark folder that does not have the same visual prominence.

### Browsing Context

Tab groups make it possible to consolidate into a single window browsing that might have been done less efficiently in multiple windows. In a limited sense, tab groups function as their own browser windows and provide a virtual environment or workspace with which a user can manage a collection of resources in the service of satisfying a specific information need. The present invention attempts to broaden the scope of that environment, making it persistent and stateful by bringing together a tab group and bookmarks into a single component, herein referred to as a browsing context.

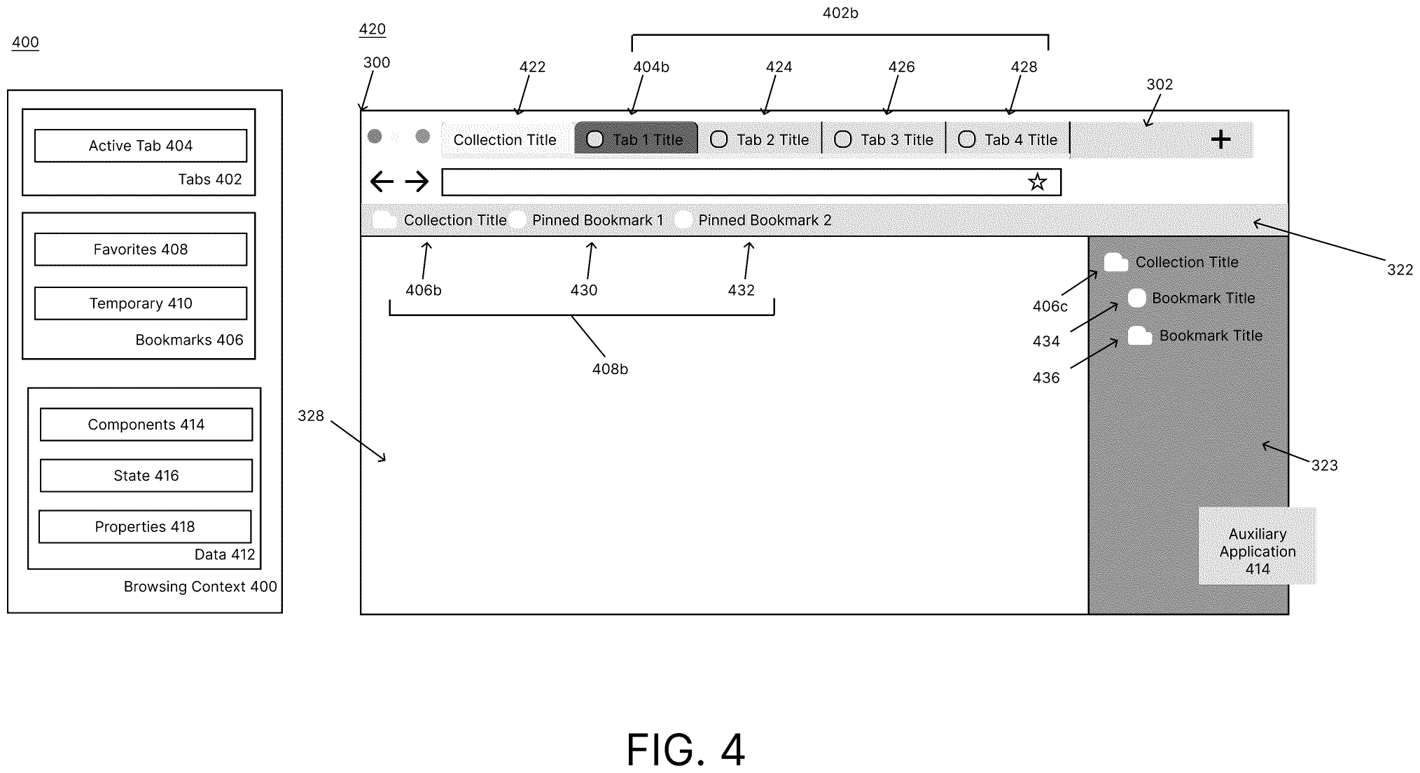

FIG. 4 shows, in accordance with one or more embodiments, a conceptual model of a browsing context 400. A browsing context includes tabs 402 which can be organized into a single set (i.e. a tab group) or a hierarchy of tabs and or tab groups. Included within the collection of tabs is an active tab 404. Just as a browser window has an active tab, so too does the tab group of the browsing context, so that when the tab group is expanded from a collapsed state it opens to the last active tab of that group. FIG. 4 also shows an example browser interface 420 that displays an active browsing context. The browsing context is considered active because its tab group 422 includes the active tab 404b of the browsing window. The browsing context's active tab 404 as depicted in the conceptual model 400 corresponds to the active tab 404b depicted in the interface example 420. The browsing context's tabs 402 correspond to the tabs 404b, 424, 426, and 428 as included in 402b.

The browsing context additionally includes bookmarks 406, which includes, aside from basic bookmarked files and bookmark folders, a special subset of favorite bookmarks 408 and another special subset of temporary bookmarks 410. In the same way that components of the browser interface change in response to a change in the active tab, the present invention augments the browser interface according to the active tab group and browsing context so that when a browsing context is made active as depicted in the example 420, the bookmark bar 322 displays the browsing context's favorite bookmarks 408b which includes bookmark folder 406b and the bookmarks 430 and 432. It should be noted that the favorite bookmarks 408b corresponds to the favorite bookmarks 408 depicted in the conceptual model 400 and that bookmark folder 406b is the bookmark location that contains the browsing context's bookmarks 408. The browsing context's bookmark folder can be included within its favorite bookmarks so as to aid retrieval of any relevant bookmarks when the bookmark display area 323 is not open and displayed within the browser window. When the bookmark display area 323 is present, as it is in the current example, it will include the active browsing context's bookmarks 406, in this case it's main bookmark folder 406c and the bookmarks 434 and 436. It should also be noted that the bookmark location may take the form of a conventional bookmark folder provided by the browser or the bookmarks may be saved within a separate database collection either locally or remotely.

While the bookmark display area 323 is depicted as a side panel, the display area may be shown as its own tab within the tab group. The display area can be thought of, more broadly, as a desktop that contains file references and may additionally include auxiliary applications, also known as widgets, such as 414 that support the user in performing tasks related to the browsing contexts. In the same way that bookmarks are specific to a browsing context, auxiliary applications may also be configured to a specific context.

In order to account for the various elements of the browsing context as described above, a browsing context also includes data 412 that is both held in memory and stored to disk either on the computing device running the web browser application or a remote database. The browsing context's data 412 includes data for each of the browsing context's components 414 or at the very least references to those components so that that data can be retrieved at run time. The browsing context's data also stores the browsing context's properties 416 and state 418.

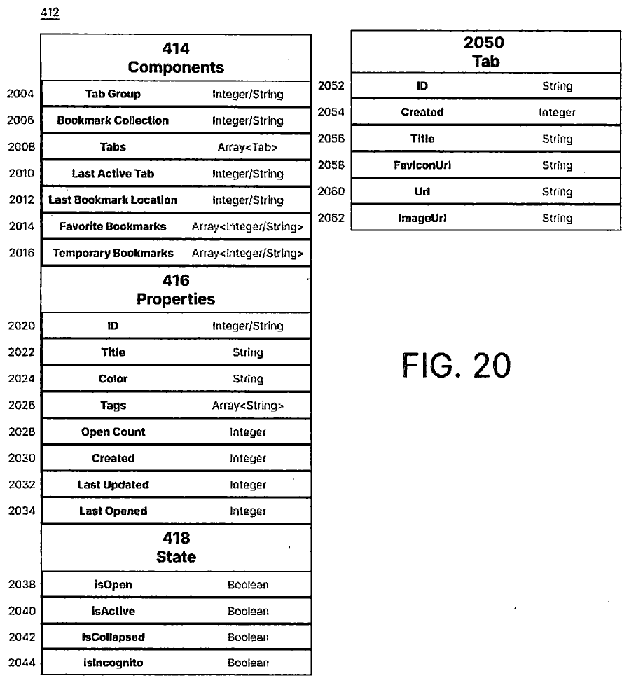

FIG. 20 shows the browsing context's data 412 in greater detail. If the present invention is implemented as a service worker which uses the browsers API then the browser context's component data 414 including the tab group 2004, bookmark folder or collection 2006, tabs 2008, last active tab 2010, last bookmark location 2012, favorite bookmarks 2014, and temporary bookmarks 2016 can be stored as reference identifiers or in the case of tabs, favorite bookmarks, and temporary bookmarks as list of reference identifiers.

It should be noted that since tabs and tab groups are temporary components it is advantageous to store more than just the reference identifier to each tab 2052, so that the tab details can be displayed to the user and used to restore the tab group when it has been closed. The tab data 2052 can include, but is not limited to, a tab's time of creation 2054, title 2056, icon URL 2058, the tab's URL 2060, and a URL of an associated image 2062 that can be displayed to the user as a representation of the tabs contents.

Any changes to the components of the browsing context will result in its data being updated. When a tab is created, removed or moved within the tab group, the list of tabs 2008 and each tab's data 2052 are updated to reflect these changes. When a tab within the browsing context's tab group is made active, the last active tab 2010 is updated. The last active tab 2010 in FIG. 20 corresponds to the active tab 404 in FIG. 4.

The browsing context's data also includes properties 416, which may include but are not limited to, the context's ID 2020, title 2022, color 2024, tags 2026, the number of times the context has been opened 2028, it's time of creation 2030, the time when the context was last updated 2032, as well as the time when the context was last opened 2034. Additionally, the titles of the tab group 422 and bookmark folder 406b,c associated with the browsing context as depicted in FIG. 4, are synchronized, so that any changes to one, updates the browsing context's title 2022 and changes the title of the other. All of these properties allow the user to organize a collection of browsing contexts and more readily retrieve them as needed.

One major problem with bookmarks is that they are not ordered by their recency of use. When a bookmark folder is created it gets appended to the list of children contained within its parent folder, so that over time it becomes harder and harder to find the most recently created folders, thereby discouraging users from using bookmarks all together for fear of never getting back to saved bookmarks. The present invention solves this black hole effect where bookmarks are created but never retrieved, by letting users order their browsing contexts and consequently their associated bookmark folders by the last update time 2032 or time of creation 2030, in this way surfacing the most recent context and collections, making them more readily retrievable by recognition rather than direct recall.

The last component of the browsing context's data are the state variables 418. A context can be open or closed as denoted by the isOpen boolean 2038. Once opened a browsing context can be collapsed or expanded as when its tab group is in a collapsed or expanded state, the value for which is stored in the isCollapsed boolean 2042. A browsing context can also be active or inactive as when its tab group includes the active tab of the browser window, the value for which is stored in the isActive boolean 2040. Lastly, the isIncognito boolean 2044 specifies whether the browsing context is to be displayed in incognito or private browsing window as opposed to a regular browsing window without any additional affordances for privacy.

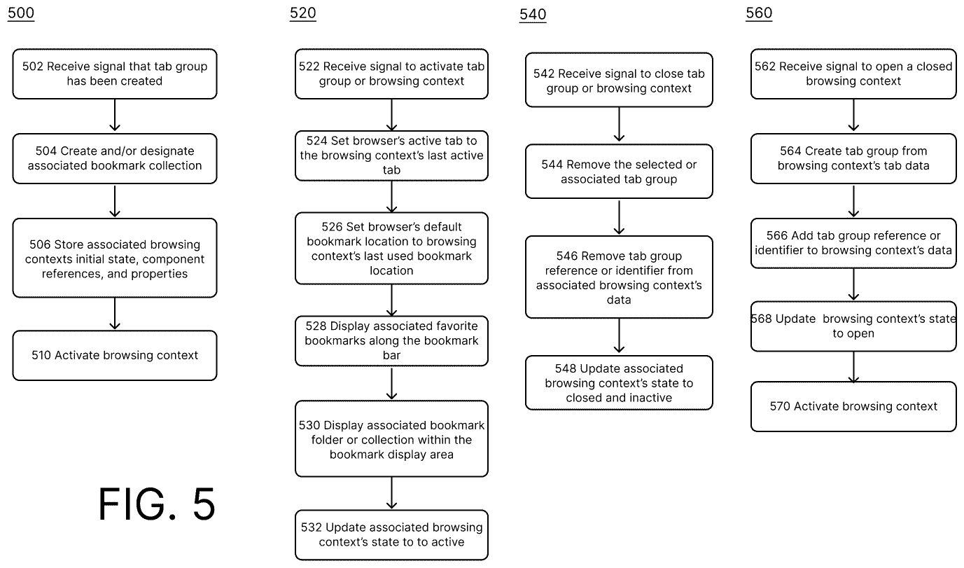

FIG. 5 shows flowcharts of example processes for creating and changing the state of a browsing context. These example processes can be implemented in software, firmware, hardware, or combinations thereof. For example, processes 500, 520, 540, and 560 can be implemented by the web browser application 124 illustrated in FIG. 1. These processes are shown as a set of acts and are not limited to the order shown for performing the operation of various acts.

The flowchart for process 500 illustrates the creation of a browsing context from a tab group. Upon receiving a signal that a tab group has been created (act 502), either manually by the user or automatically by the web browser application, process 500 creates a bookmark folder or location with the title of the tab group (act 504). The initial data for the browsing context, including its state, components, and properties, is then created and stored to a persistent storage medium (act 506) either locally or remotely, and finally the browsing context is made active (act 510) consistent with process 520 described below.

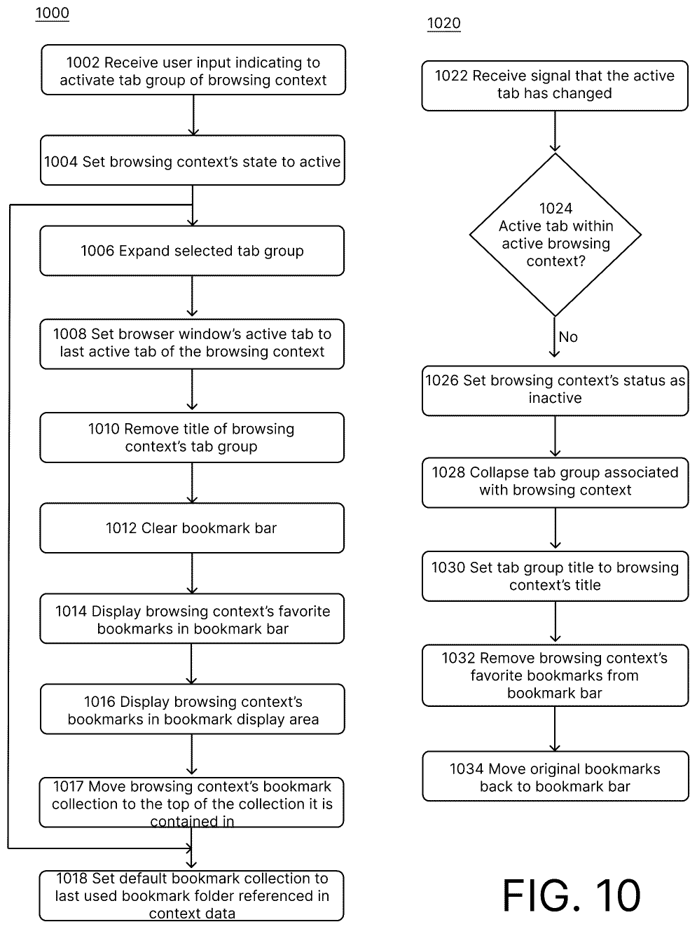

The flowchart for process 520 shows a simplified example for making a browsing context active. A more detailed example process is shown in FIG. 10 and described in a later section. Upon receiving a signal to activate a tab group or browsing context (act 522), process 520 sets the browser window's active tab to last the active tab of the browsing context (act 524), the reference to which 2010 is stored in the browsing context's data 412. The browser's default bookmark location is then set to the browsing context's last used bookmark location (act 526), the reference to which 2012 is also stored in the browsing context's data 412. The browser's default bookmark location is the bookmark folder that bookmark is saved to when the user clicks the bookmark icon 320 in FIG. 3. The browsing context's favorite bookmarks, if any, are then displayed along the bookmark bar (act 528) and the browsing context's bookmarks are displayed within the bookmark display area (act 530). Finally, the browsing context's state as stored in its data is updated to reflect that the browsing context is now active (act 532). For example, the state variable isActive 2040 can be set to true.

The flowchart for process 540 shows what occurs when a browsing context or its associated tab group is closed. Upon receiving a user input signaling to close a browsing context or its tab group (act 542), process 540 removes the selected tab group or the tab group of the selected browsing context (act 544). The tab group reference 2004 is removed from the browsing context's data (act 546), while its tab data 2008 is retained so that a tab group can be created and the tabs restored when the browsing context is opened again. Lastly, the browsing context's state is updated to reflect that the browsing context's state has changed to closed and inactive (act 548). Both the state variable isOpen 2038 and isActive 2040 would be set to false.

The flowchart for process 560 shows what occurs when a browsing context is opened from a closed state. Upon receiving a user input signaling to open a browsing context (act 562), a tab group is created from the browsing context's tab data 2008 (act 564). A reference to the tab group is then stored within the browsing context's data (act 566). The browsing context's state is updated to reflect that context is open (act 568) and the browsing context is then activated (act 570) in accordance with process 520.

### Grouping Tabs

The present invention relies heavily upon the creation of tab groups. As mentioned previously, most users do not use tab groups either because they do not know that the feature exists or because they do not wish to expend the effort required to create them. In order to encourage the use of tab groups, the techniques described herein make the process of creating tab groups simple and convenient, by one method reducing the effort of manually creating tab groups to that of single click, and by another method automating the process, relying upon the implicit relationship between tabs the user has opened.

### Automatic Tab Grouping

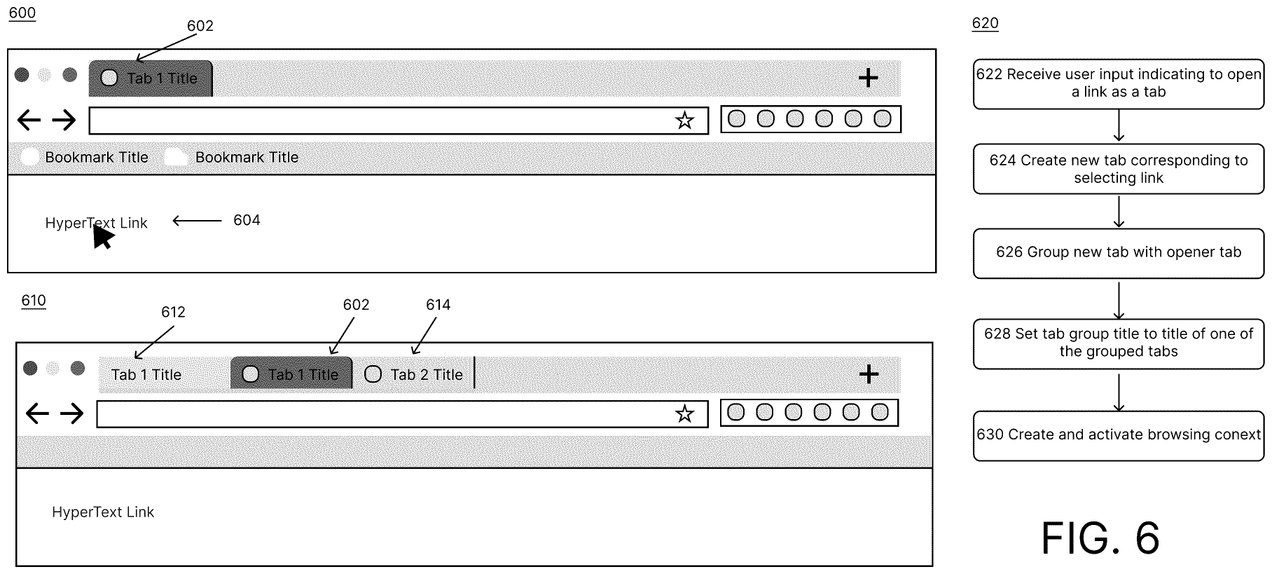

FIG. 6 illustrates an example process 620 by which a user triggers an automatic grouping as well as examples 600 and 610 of the user interfaces before and after the process is performed. Process 620 can be implemented in software, firmware, hardware, or combinations thereof. For example, process 620 can be implemented by the web browser application 124 illustrated in FIG. 1. Process 620 is shown as a set of acts and is not limited to the order shown for performing the operation of various acts.

In the example user interface interaction 600 a user attempts to open the link 604 as a new tab. This action can be taken for example by pressing a keyboard key while clicking the link. Upon receiving the signal of the user's intention to open a link as a new tab (act 622), a new tab 614 is created and loads the URL of the selected link (act 624). The new tab 614 and the opener tab 602 are grouped together (act 626) and the title of the tab group 612 is taken from the title of one of the grouped tabs (act 628), in this case the opener tab 602. Once the tab group is created, a browsing context is created and activated consistent with the processes 500 and 520 described above and illustrated in FIG. 5.

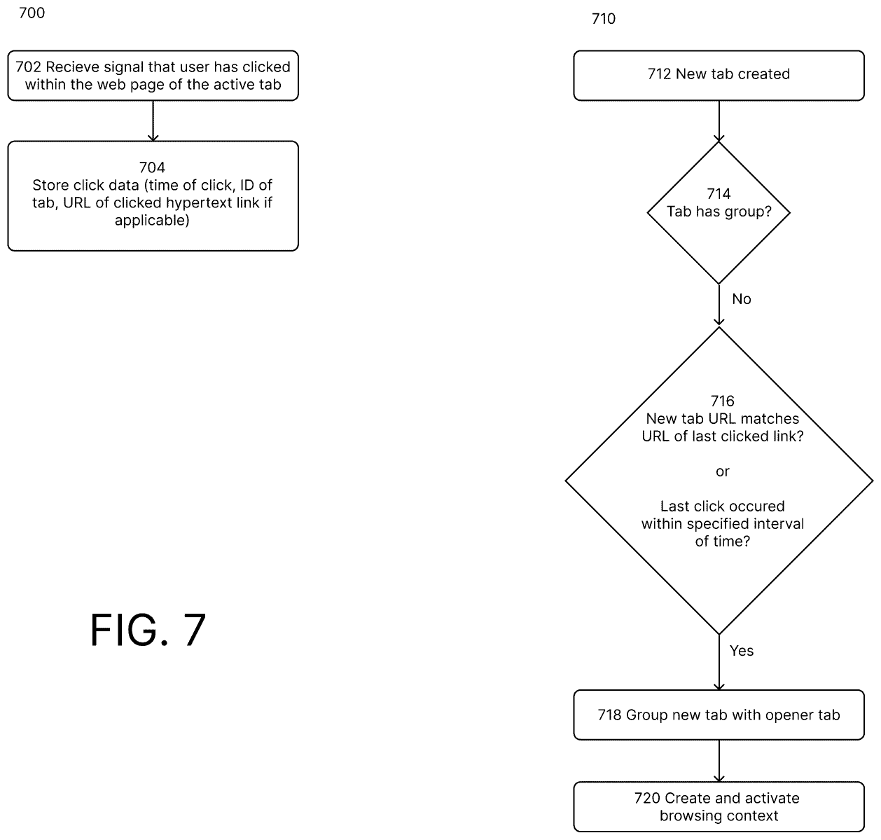

FIG. 7 illustrates in greater detail the logic for automatically grouping tabs and creating a new context, with the presented method requiring two processes, one process 700 for registering a user click within the web page of the active tab and one process 710 for responding to the creation of the tab. Processes 700 and 710 can be implemented in software, firmware, hardware, or combinations thereof. For example, the processes can be implemented by the web browser application 124 illustrated in FIG. 1. The processes are shown as a set of acts and are not limited to the order shown for performing the operation of various acts.

Upon receiving a signal indicating that the user has clicked within the web page of the active tab (act 702), process 700 store data associated with the click (act 704). This data includes the time of the click as well as the ID and URL of the active tab. Upon receiving a signal that a tab has been created (act 712), process 710 determines whether the tab belongs to an existing group or browsing context (act 714). If the tab does not belong to a group, the created tab's ID, URL and creation time are checked against those of the last click data (act 716). In the case that neither the IDs or URLs match, the time of the last click is compared to the creation time of the new tab. If the time of the last click and creation of the new tab is sufficiently close or the IDs or URLs are matched, the new tab is grouped with its opener (act 718) and a new browsing context is created and activated consistent with the processes 500 and 520 detailed in FIG. 5. The time based method of grouping is advantageous for corner cases in which the opener tab of a newly created tab is not provided by the browser or a link that the user has clicked contains no associated URL within the HTML element that was clicked.

### Manual Tab Grouping

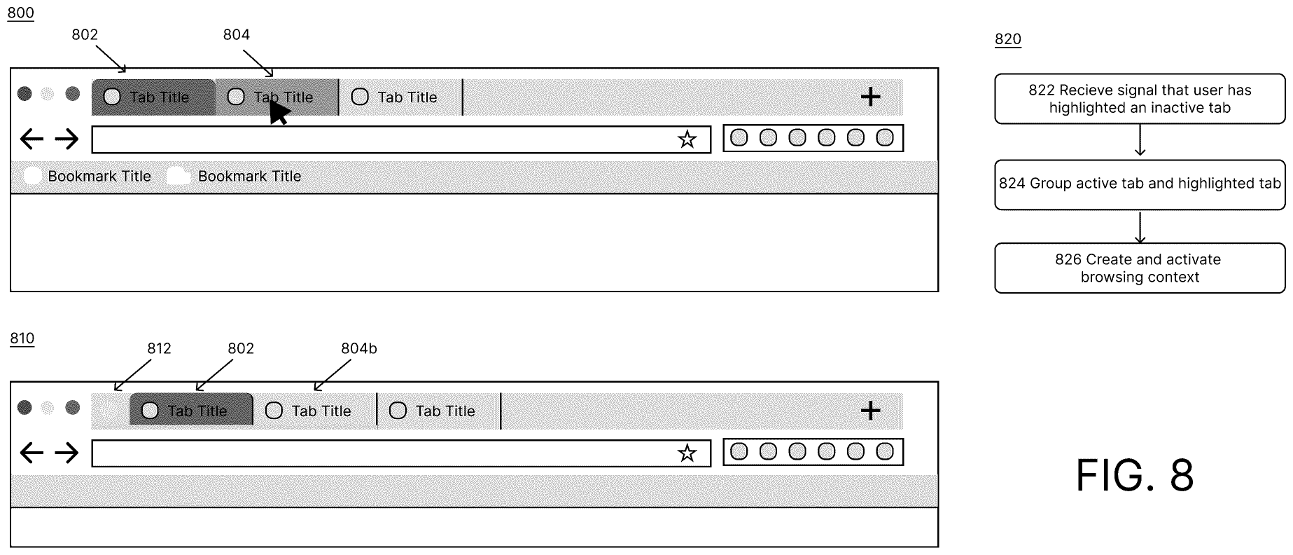

There may be situations where related tabs are not automatically grouped. FIG. 8 illustrates, in accordance with one or more embodiments, how users may carry out a manual grouping of tabs that only requires a single action. When a tab is active it is in a highlighted state with a visual indication such as darker shading compared to the shading of inactive tabs. A plurality of tabs may be highlighted simultaneously and a user may select with a single click to highlight tabs that are not active. As shown in a example browser window 800 where one tab is active 802 and another is highlighted 804, highlighted tabs that are not active will be visually distinguished from tabs that are not highlighted while the active tab will also be visually distinguished as with darker shading to show that it is both highlighted and active.

The process of manually grouping an active tab with a highlighted is depicted in the flow diagram 820. Process 820 can be implemented in software, firmware, hardware, or combinations thereof. For example, process 820 can be implemented by the web browser application 124 illustrated in FIG. 1. Process 820 is shown as a set of acts and is not limited to the order shown for performing the operation of various acts.

Upon receiving user input signaling to highlight an inactive tab 804 (act 822), the process 820 groups the active tab 802 and highlighted tab 804 into a tab group 812 (act 824) and creates and activates a browsing context (act 826) consistent with processes 500 and 520 described above and shown in FIG. 5. This method of manually grouping is preferable to the default method where the user must right click on a tab to open a context menu, select the option to create a new tab group and then drag the other tab into the group. This three step process is compressed into a single action, saving the user time and effort.

In the case that the active tab is already in a tab group the same process can be applied omitting the act 826. The highlighted tab would simply be moved to the tab group of the active tab rather than creating a new tab group and browsing context. This one click method of grouping is preferable to adding a tab to an existing tab group by either dragging and dropping the tab or selecting to move the tab through a drop down menu since it also reduces the time and effort required to perform the tab grouping action.

### Activating and Deactivating Browsing Contexts

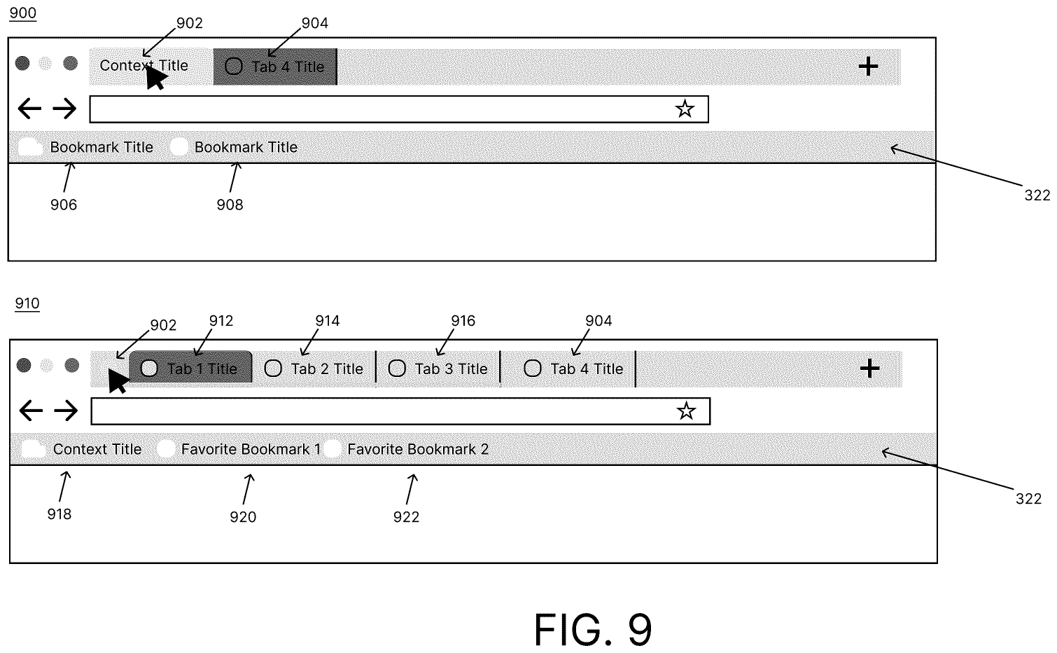

As mentioned above, an open browsing context has two possible states, active and inactive. A browsing context and its associated tab group are considered active when the active tab of the browser window is within the tab group or inactive, as when the active tab of the browser window is outside of the tab group. A user may signal to activate a browsing context and its associated tab group by clicking the label of the tab group when it is collapsed or by making active a tab within the tab group when the previous active tab is outside of the tab group. The activation and deactivation of a browsing context and/or tab group, triggers a set of processes that are depicted in FIGS. 9 and 10.

FIG. 9 shows, in accordance with one or more embodiments, examples 900 and 910 of a browser window in which an inactive browsing context with collapsed tab group becomes an active browsing context and vice versa. FIG. 10 illustrates flowcharts for an example process 1000 for activating a browsing context and an example process 1020 for deactivating a browsing context. These example processes can be implemented in software, firmware, hardware, or combinations thereof. For example, process 1000 and 1020 can be implemented by the web browser application illustrated in FIG. 1. Both processes are shown as a set of acts and are not limited to the order shown for performing the operation of various acts.

In the example 900, a user selects with the mouse cursor the label of the tab group 902 which he or she wishes to expand and make active. The tab group 902 is considered inactive both because it is collapsed and because it does not include the browser window's active tab 904. Additionally, it should be noted the bookmark bar 322, includes a bookmark folder 906 and bookmarked resource 908 that do not belong to the closed browsing context associated with the tab group 902. Upon receiving a signal from the user to activate the browsing context (act 1002), the context's data is updated to reflect the state change (act 1004). In the case that the tab group of the browsing context is transitioned from a collapsed to an expanded state, as shown in the example in FIG. 9, the browsing context's tab group is expanded (act 1006) and its last active tab 912 is set as the active tab for the browser window (act 1008). Optionally, the title of the tab group 902 is removed (act 1010) to make space along the tab bar. The bookmark bar 322 may also be cleared (act 1012) and repopulated with the browsing context's favorite bookmarks (act 1014) which in the example 910 includes the context's bookmark folder 918 and the favorite bookmarks 920 and 922. The browsing context's bookmark folder or collection is optionally displayed along the bookmark bar, within the bookmark display area as shown in the FIG. 3 or within a tab within the browsing context's tab group (act 1016). Additionally, the bookmark folder or location of the browsing context's can be moved to the top of the collection that contains it (act 1017). If the process is implemented as an extension which uses the browser's API, this step can be done by setting the index of the browsing context's bookmark folder to zero. The advantage of moving the browsing context's bookmark folder in this way is that it permits the user to more easily find the folder within the bookmark tree displayed in the bookmark display area and to navigate to bookmark folders according to their recency of use. Lastly, the default bookmark location is set to the last used bookmark location stored in the browsing context's data (act 1018) so that when the user goes to save a tab or link they don't have to manually specify which bookmark folder to save the resource to. In the case that the user has not bookmarked any resources within the present browsing context, the default bookmark location would be set to the browsing context's bookmark folder or location.

The example process 1020 shows the steps that are taken when a browsing context is deactivated. As depicted in FIG. 2, the tab module 220 within the service worker contains a listener for changes to the browser's active tab 225. Upon receiving a signal indicating that the active tab has changed (act 1022) the process 1020 determines whether the new active tab is within the active browsing context (act 1024). If the active tab is not within the tab group of the active browsing context, then its context's data is set to reflect this change in state (act 1026). Optionally, the browsing context's tab group is collapsed to conserve room on the tab bar (act 1028), the tab group's title is restored to that of the browsing context (act 1030), the browsing context's favorite bookmarks 918, 920, and 922 are removed from the bookmark bar (act 1032), and the previously cleared bookmarks 906 and 908 are moved back to the bookmark bar (act 1034).

### Bookmarking Tabs

In contrast to the simplicity of bookmarking a page within a book, bookmarking a web page entails multiple steps and additional cognitive effort to decide where to save the URL. This added effort is more than the average user is willing to expend to save resources for later, especially if they do not know if the resources are worth saving permanently. Users will instead opt to use tabs both as temporary and permanent bookmarks, with the latter case contributing to the phenomenon known as tab hoarding, where a user keeps tabs open over multiple browsing sessions for fear of forever losing the tab's content. The present invention makes bookmarking a link or web pages as convenient as creating a new tab with the added benefit that the user can conserve space along the tab bar and easily retrieve saved resources during a later browsing session.

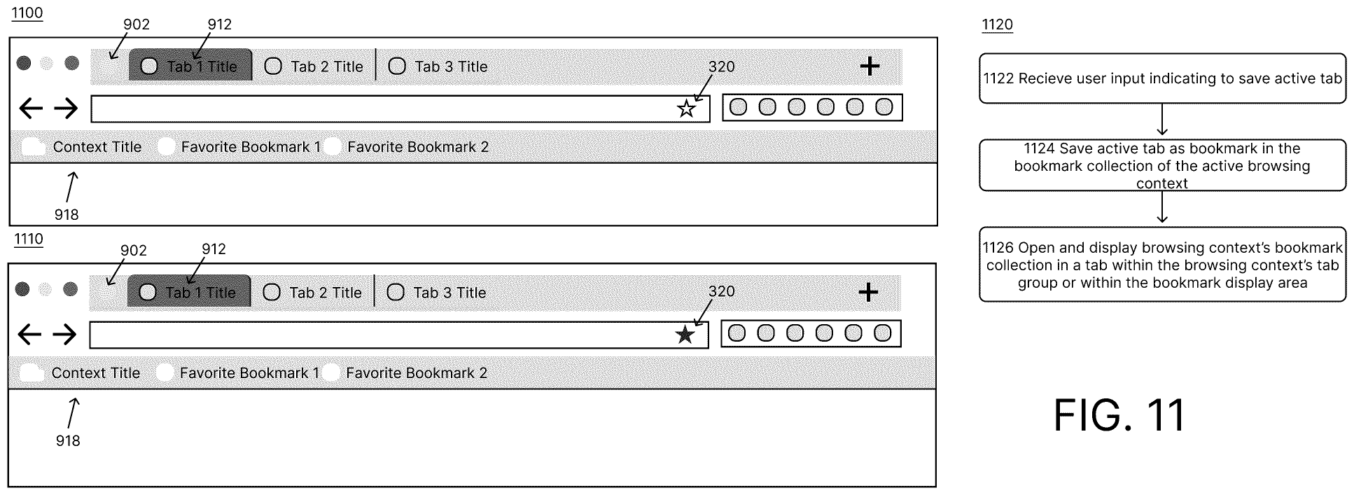

FIG. 11 illustrates, in accordance with one or more embodiments, examples of the browser interface before a bookmark is saved 1100 and after a bookmark is saved 1110, as well as a flowchart of the process 1120 of saving a resource from the active tab. As previously mentioned, when a tab group such as 902 is expanded and its browsing context is active, the context's bookmark folder or location 918 is set as the web browser's default bookmark location, so that when the user clicks the bookmark icon 320, signaling the user's intention to save the active tab 912 (act 1122), the active tab 912 is saved a bookmark in the active context's bookmark folder (act 1124). The bookmark icon 320 would then reflect through a visual indicator that the tab had been saved as shown in example 1110. Optionally, upon saving the bookmark, the browsing context's bookmark collection is opened and displayed within a tab within the browsing context's tab group or within the bookmark display area (act 1126).

For mainstream web browsers, when an item is bookmarked by clicking the bookmark icon, a pop up is presented to the user so that he or she may select a location to save the bookmarked resource. With the present invention, the user no longer needs to select a bookmark location and consequently does not need to interact with the bookmarking interface presented by the pop up. The simplicity of the process 1120 is indicative of the convenience afforded to the user by improved context management, whereby a multistep process for the user is compressed to a single action.

### Temporary Bookmarks

Conventional web browsers do not permit users to save links within web pages as bookmarks. The present invention not only makes it easy to save links from web pages with a single action but also to save them in a temporary manner so that they are removed upon opening. When links are bookmarked in this way the user can select and queue multiple links from a web search or an article without consideration of whether the link is worth saving permanently. This method of temporarily saving links provides a preferred substitute for opening links as new tabs, which can result in tab overload. The automatic deletion of these bookmarks ensures that the bookmark folder does not become cluttered with extraneous bookmarks that are not relevant or useful.

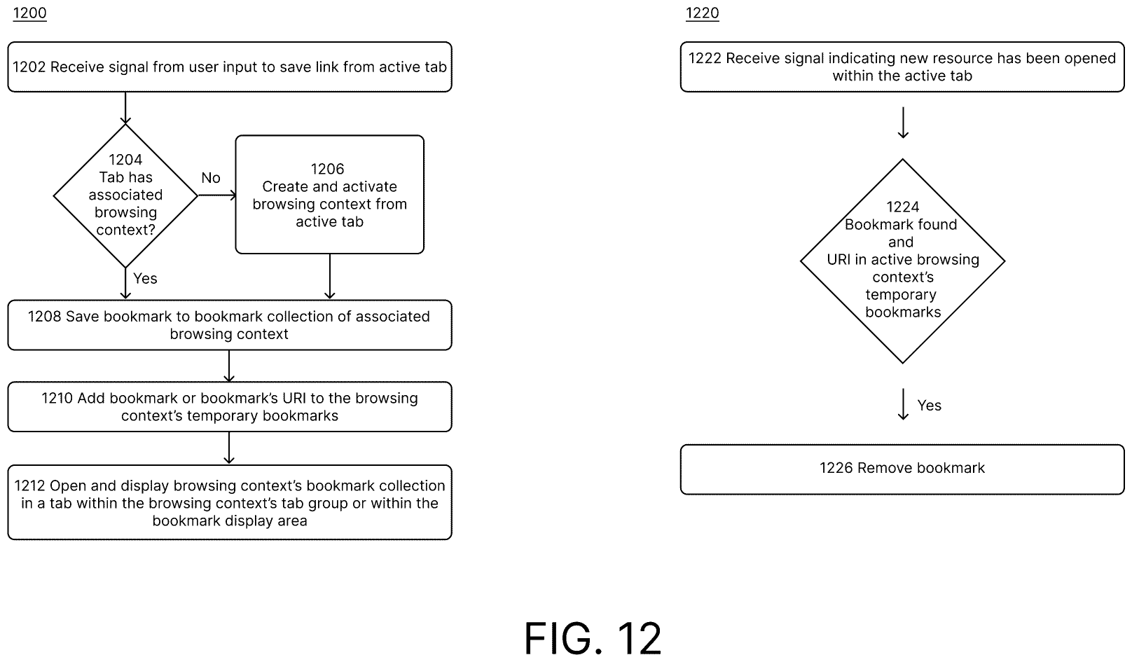

FIG. 12 illustrates example processes 1200 and 1220 that permit a user to save a link as a temporary bookmark within the bookmark folder or location of the active browsing context. Processes 1200 and 1220 can be implemented in software, firmware, hardware, or combinations thereof. For example, these processes can be implemented by browser application 124 illustrated in FIG. 1. Both processes are shown as sets of acts and are not limited to the order shown for performing the operation of various acts.

Upon receiving a user input signaling to save a link from within the active tab (act 1202) the process 1200 determines if the active tab has an associated, opened tab group (act 1204). The user input can take many forms. For example a user input may include clicking the link in conjunction with pressing down a key on the keyboard or, in a mobile environment, it may include a swipe of a link with the user's finger.

If the active tab is not within a browsing context then one is created and activated (act 1206). The active tab is then saved as a bookmark within the bookmark collection of the active browsing context (act 1208) and the bookmark is added to the active browsing context's collection of temporary bookmarks (act 1210). The collection of temporary bookmarks can be saved within the browsing context's data or it may be saved to its own database collection, or temporary bookmarks may be tagged with some marker indicating that it is a temporary bookmark. Optionally, upon saving the bookmark, the browsing context's bookmark collection is opened and displayed within a tab within the browsing context's tab group or within the bookmark display area (act 1212).

Upon receiving a signal that a resource has been open or loaded within the active tab of the browser window (act 1222), process 1220 determines whether the resource has a corresponding bookmark, an associated browsing contexts, and whether the temporary bookmarks of that browsing context includes a bookmark with the resource's URL (act 1224). If the resource is determined to have a corresponding temporary bookmark then the bookmark is removed from the browsing context's bookmark collection (act 1226).

### Favorite Bookmarks

Frequently visited web resources are often saved to the bookmark bar so that they can be quickly opened without having to input their associated URL within the address bar. The present invention permits the user to save context specific resources to the bookmark bar, displaying them when a browsing context is active and removing them when a browsing context is made inactive.

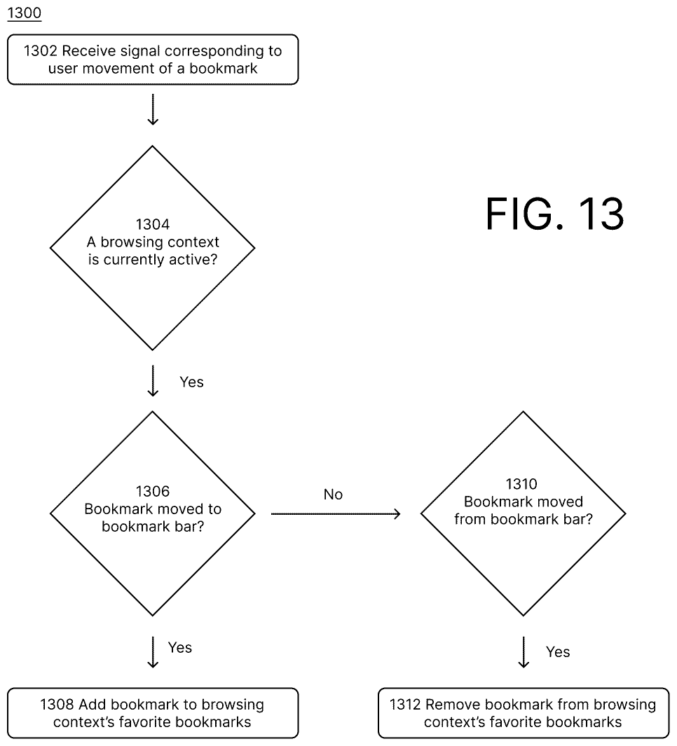

FIG. 13 illustrates a flowchart for an example process 1300 for updating the set of favorite bookmarks associated with a particular tab group and/or browsing context. Process 1300 can be implemented in software, firmware, hardware, or combinations thereof. For example, process 1300 can be implemented by the web browser application 124 illustrated in FIG. 1. Process 1300 is shown as a set of acts and is not limited to the order shown for performing the operation of various acts.

In process 1300, a signal is received from the user interface to indicate that a bookmark has been moved (act 1302). A bookmark may be moved by dragging it from one display area within the user interface and dropping it into another display area. Upon receiving the signal that a bookmark has been moved, process 1300 checks if a browsing context is active (act 1304). If a browsing context is active the process proceeds and checks whether the bookmark has been moved to the bookmark bar (act 1306) or moved from the bookmark bar (act 1310). If the bookmark has been moved to the bookmark bar, then the bookmark is designated as a favorite bookmark for the active browsing context (act 1308). The set of favorite bookmarks is arranged to reflect how the bookmarks are displayed within the user interface. If the bookmark is moved from the bookmark bar while a browsing context is active, the bookmark is removed from the browsing context's favorite bookmarks (act 1312).

When the browsing context is made inactive, either through collapsing or closing its tab group, the favorite bookmarks displayed along the bookmark bar are removed from the bookmark bar, consistent with process 1020 in FIG. 10, and when the collection is made active again, the favorite bookmarks are displayed along the bookmark bar, consistent with process 1000 in FIG. 10, and reflecting all changes made to the collection's favorite bookmarks in process 1300.

Moving and Saving Tabs from the Omnibox

A user may open a tab with a resource relevant to a particular browsing context while a tab group associated with the browsing context is not presently displayed within the user interface or the tab group is inactive and/or collapsed. If the tab group is opened but inactive, the user could expand the tab group and drag the relevant tab into the group. The user would then be able to save the tab according to process 1120 of FIG. 11 described above. Alternatively, if no associated tab group is open, the user could use the browser's bookmark interface to traverse the bookmark tree and select the appropriate bookmark location to save the tab. It should be noted that, at present, web browsers do not permit users to save an active tab by searching for a desired bookmark location through a text input field such as the browser omnibox 318 in FIG. 3. Both of the above approaches to saving a tab require effort that a user may not wish to expend.

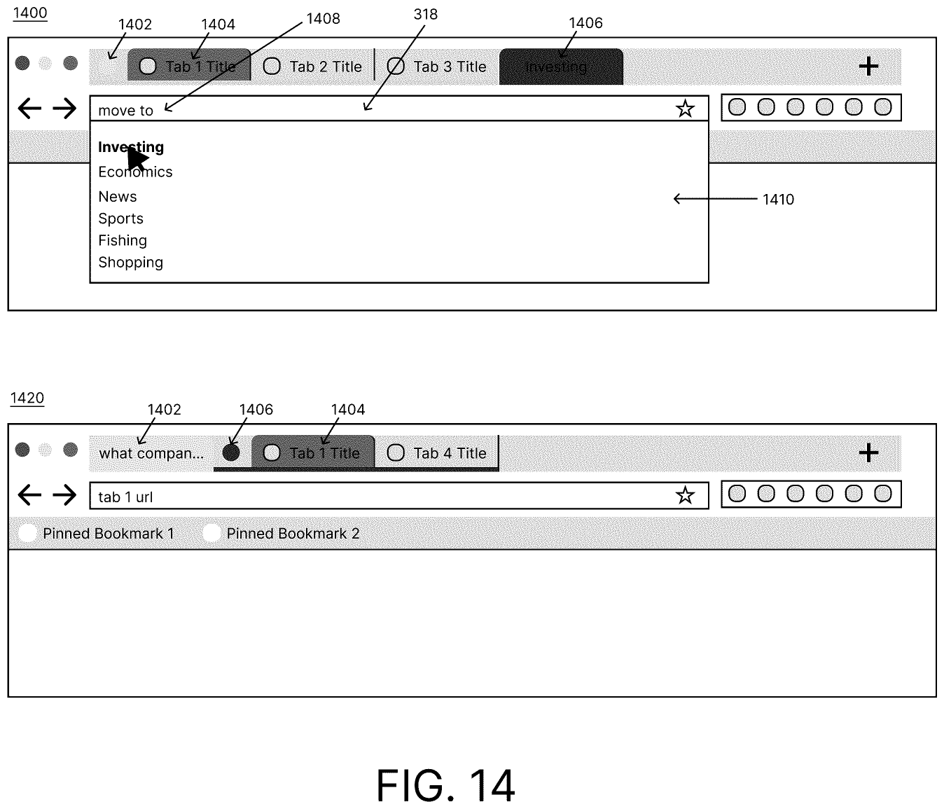

FIG. 14 illustrates an example browser interface 1400, in accordance with one or more embodiments, wherein a user can move an active tab 1404 to a desired tab group and/or browsing context 1406 by entering a command 1408 into the omnibox 318. In the present example the desired browsing context has an associated tab group 1406 which is open but collapsed. Also illustrated in FIG. 14 is an example 1420 of the browser interface after the active tab has been moved to the desired browsing context. The tab group 1406 is shown in an expanded state and contains the active tab 1402. It should be noted that while the present example only illustrates moving an active tab from one tab group to another tab group, the invention permits changing the location of an ungrouped active tab, and moving an active tab (whether grouped or not grouped) to a bookmark location that does not have an associated tab group (e.g. a bookmark folder) or a browsing context for which an associated tab group is not opened.

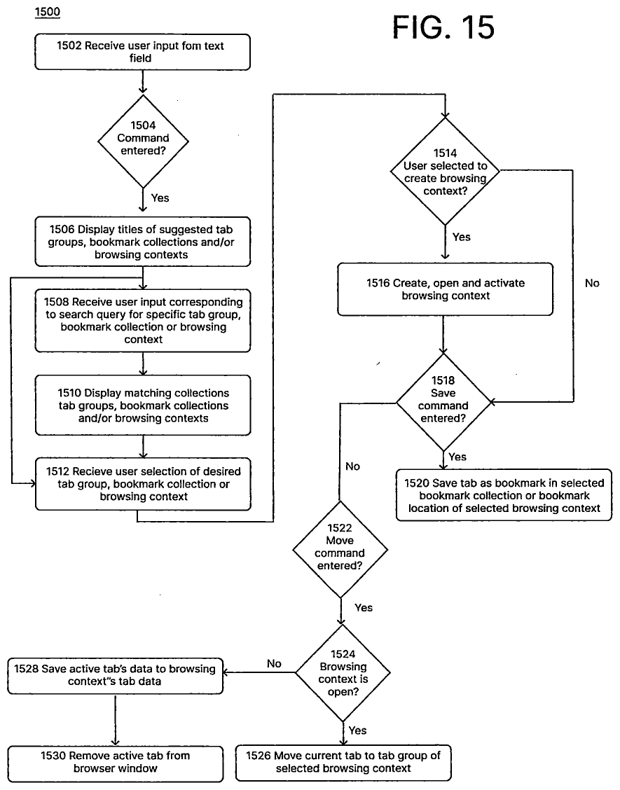

FIG. 15 illustrates a flowchart of an example process 1500 for moving or saving an active tab to a desired collection, whether that be a tab group, bookmark location or browsing context. Process 1500 can be implemented in software, firmware, hardware, or combinations thereof. For example, process 1500 can be implemented by the web browser application 124 illustrated in FIG. 1. Process 1500 is shown as a set of acts and is not limited to the order shown for performing the operation of various acts.

Upon receiving an user input (act 1502) from within the omnibox, process 1500 checks whether the input is a command (act 1504) either to move or save the active tab. If a command is entered then a list of suggested collections are displayed to the user (act 1506).

If the desired collection is not present, the user may optionally input a search query after the command (act 1508), and in response the list of suggested collections will be updated to show those that match the users query (act 1510). The user could then select the desired collection from the supplied suggestions (act 1512), and upon receiving the user's selection move or save the active tab in accordance with the received command.

The user's query may not correspond to an existing collection or browsing context, in which case the user may wish to create a browsing context using the query string as the title of the newly created context. Among the suggestions provided to the user, one of the suggestions can be to create a new browsing context. If the process 1500 determines that the user has selected to create a new browsing context (act 1514), then a new browsing context that takes its title from the query string is created and activated (act 1516).

If the process 1500 determines that the user issued a save command (act 1518) then the active tab would be saved to the selected bookmark location or the bookmark location of the selected browsing context (act 1520) and the user would be provided with visual feedback within the user interface, such as displaying the bookmark button in the omnibox with its icon filled in.

If the process 1500 determines that the user issued a move command (act 1522), the process would check if the selected collection was a tab group or a browsing context that was open (act 1524). If the selected tab group or browsing context or associated tab group were opened the active tab would be moved to the selected tab group or the tab group of the selected browsing context (act 1526) as depicted in example 1420 of FIG. 14. On the other hand, if the selected collection is a browsing context that does not have an open tab group, the active tab's data would be saved to the tab data of selected browsing context (act 1528) so that when the collection is activated, its tab group would include a tab corresponding to the active tab 1402. Optionally, the active tab could then be removed from the interface (act 1530), signaling to the user that move action had been executed.

The advantage of using the omnibox in this way is that it affords the user a convenient method for moving a tab to specific tab group or saving a tab to a specific bookmark location with little effort, regardless of how many tab groups and windows are opened or how many bookmark folders have been created.

### Retrieving and Restoring Contexts

The omnibox may also be used to search for and open a collection of resources. Conventional web browsers only permit users to search for and open a single resource or file from the omnibox. The resource may be retrieved from a user's bookmarks or browsing history. Web browsers do not, however, permit the user to search from within the omnibox to retrieve a saved tab group or bookmark folder.

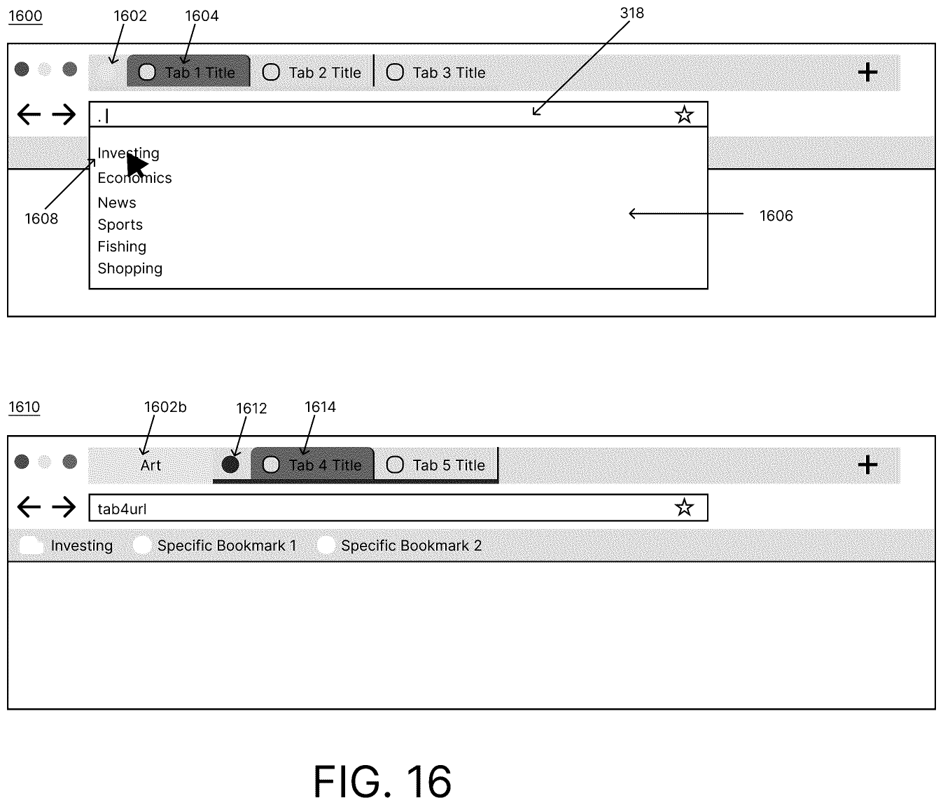

FIG. 16, shows in accordance with one or more embodiments, an example 1600 of browser interface in which a user searches from the omnibox 318 for a closed browsing context 1608, and another example 1610 of the same browser interface when the desired browsing context has been retrieved and activated.

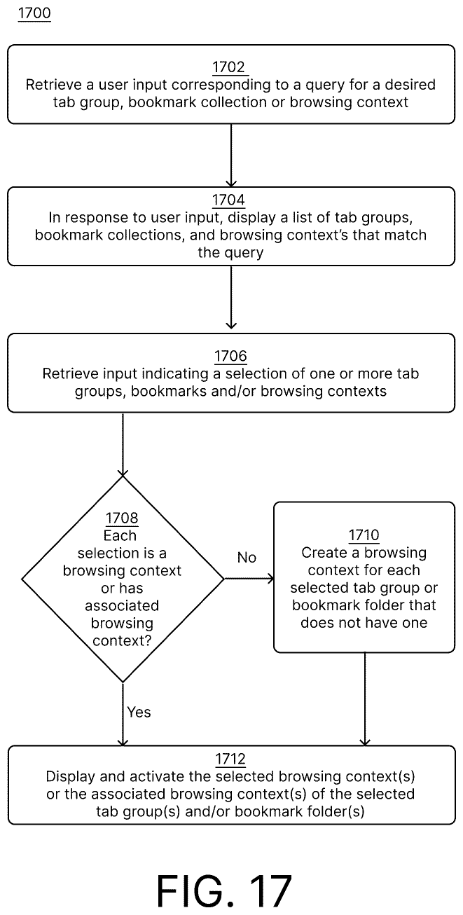

FIG. 17 is a flowchart illustrating an example process 1700 for retrieving a collection of resources and displaying them within the browser interface as tabs within a tab group and/or as bookmarks within the bookmark bar. Process 1700 can be implemented in software, firmware, hardware, or combinations thereof. For example, process 1700 can be implemented by the web browser application as illustrated in FIG. 1. Process 1700 is shown as a set of acts and is not limited to the order shown for performing the operation of various acts.

In process 1700, a user input is received to initiate a search for a collection of web resources (act 1702). A collection may take a variety of forms such as a tab group, a bookmark folder or a browsing context. An example of such a user input would be clicking anywhere within the omnibox 318, in this way indicating that the user would like to input text corresponding to URL or search query.

In response to the search query, the user is presented with a list of suggested collections 1606 that match the provided query (act 1704) The user may then identify and select from the suggestions a desired collection 1608. It should be noted that while the example 1600 shows the user selecting only a single collection to open, the present invention permits the selection of a plurality of collections. The user may indicate their selection by clicking the displayed reference to the collections he or she wishes to open. Upon receiving the user selection (act 1706), the process 1700 determines if each of the selected collections is a browsing context or has an associated browsing context (act 1708). A browsing context is created for any selected collection that is not a browsing context or does not have an associated browsing context (act 1710). Each of the selected or created browsing contexts is then opened and displayed within a browser window or multiple browser windows if necessary (act 1712). In the example 1600, the desired collection 1608 is selected and its associated tab group 1612 is displayed within the browser window as expanded and active and its associated bookmarks are displayed along the bookmark bar. It should be noted that in the case a user selects to open a bookmark collection that does not have an associated tab group, the browsing context can be created such that its tab group consists of a tab that displays the bookmark collection. Additionally the contents of the bookmark collection may be set as the favorite bookmarks for the created browsing context so that they are displayed along the bookmark bar for easy retrieval.

A user may also wish to restore an existing browsing context when a bookmark or multiple bookmarks within its associated bookmark collection is opened. The user may perform this action by retrieving a desired bookmark through a query input within the omnibox or by opening a bookmark or bookmark folder from the web browser application's bookmark interface.

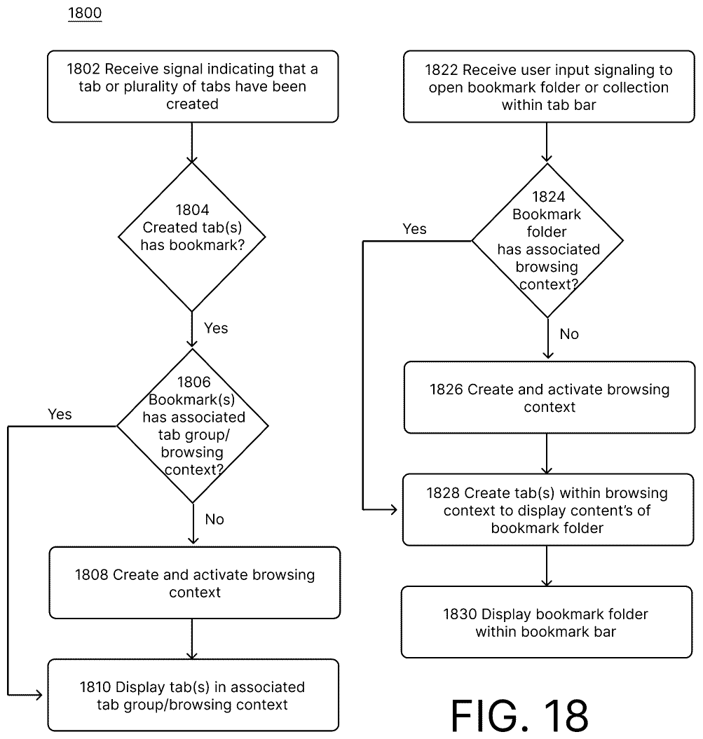

FIG. 18 includes flow charts illustrating example processes 1800 and 1820 for restoring or creating a browsing context from bookmarks. The processes can be implemented in software, firmware, hardware, or combinations thereof. For example, processes 1800 and 1820 can be implemented by the web browser application illustrated in FIG. 1. These processes are shown as a set of acts and are not limited to the order shown for performing the operation of various acts.

Upon receiving a signal that a tab or plurality of tabs has been created (act 1802), the process 1800 determines if the created tabs have corresponding bookmarks (act 1804). If the created tab or tabs do have corresponding bookmarks, process 1800 determines if the bookmarks are associated with a browsing context (act 1806). For example, a browsing context's bookmark collection may include the retrieved bookmark(s) or the browsing context's bookmark folder may include the retrieved bookmark(s) within one of its subfolders.

If an associated browsing context is not found one is created (act 1808). The newly created browsing context would include a tab group containing the created tabs and its bookmark collection would be set to the bookmark collection or folder containing the retrieved bookmark(s). Additionally the parent bookmark collection or any of its contents may be set as the browsing context's favorite bookmarks so that these bookmarks are displayed along the bookmark bar and made easily retrievable by the user. The existing or created browsing context is then displayed/opened in the browser window and activated (act 1810) with the opened tabs being displayed within the browsing context's tab group.

Alternatively, the user may attempt to open a bookmark folder or collection as tabs within the tab bar. For example, a user can drag and drop a bookmark folder into the tab bar to indicate this intention. Upon receiving a signal indicating the user intention to open a bookmark folder within the tab bar (act 1822), process 1820 determines if the bookmark folder has an associated tab group or browsing context (act 1824). If no browsing context exists, then one is created (act 1826). One or more tabs are then added to the tab group of created browsing context (act 1828). The tab(s) that are added to the tab group can either correspond to the top level bookmarks within the bookmark folder or a single tab can be added to the tab group that contains the contents of the bookmark folder. Optionally, the bookmark folder can be moved and displayed within the bookmark bar (act 1830), so as to give the user another means of ready access to the selected bookmark folder.

### Closing Multiple Contexts

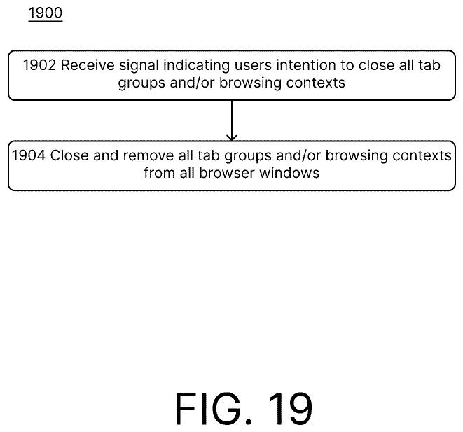

FIG. 19 is a flowchart illustrating an example process 1900 for closing multiple tab groups and browsing contexts with a single action. Process 1900 can be implemented in software, firmware, hardware, or combinations thereof. For example, process 1900 can be implemented by the web browser application illustrated in FIG. 1. Process 1900 is shown as a set of acts and is not limited to the order shown for performing the operation of various acts. Upon receiving a user input signaling to close all tab groups and/or browsing contexts (act 1902), process 1900 removes all tab groups from the browser window and closes all associated browsing contexts (act 1904) consistent with process 540 illustrated in FIG. 5. The advantage of process 1900 is that the user is able to close out, with a single action, all of his or her defined information tasks and related resources while keeping open all unclassified resources that the user has not yet filed away. This method of shutting down is preferred in contrast to the alternative method of closing the web browser application altogether, so that all the tabs that had not been filed into a tab group or bookmark folder would be lost to the web browser's history, consequently making it difficult for the user to find and restore content from those closed tabs.

1. A computer implemented method for managing tabs and bookmarks within a web browser, comprising:
upon the creation of a tab group,
naming the tab group based on the title of one or a plurality of tabs in said tab group;
creating a bookmark folder or location associated with said tab group and displaying said bookmark folder within the interface of said web browser;
setting the default bookmark folder or location of said web browser to said bookmark folder of said tab group;
upon changing the active tab of said web browser,
from an ungrouped tab to a tab within a tab group,
displaying said tab group's associated bookmark folder, bookmarks and auxiliary applications within the web browser interface;
setting the default bookmark folder or location of said web browser to said tab group's associated bookmark folder or location;
from a tab within a tab group to an ungrouped tab,
removing said tab group's associated bookmark folder, bookmarks and
auxiliary applications from said web browser interface.

2. Upon a user signal with a mouse click, finger tap or finger swipe on a universal resource locator (URL) displayed within the active tab of the active tab group,
creating a bookmark for said URL in said tab group's associated bookmark folder or
opening said URL as a tab within said tab group;
removing said bookmark when the user signals to open said bookmark as a tab.

3. Upon a user signal to save a tab within a tab group,
creating a bookmark with said tab's URL and storing said bookmark in said tab group's associated bookmark folder.

4. Upon changing the active tab of said web browser from an ungrouped tab to a tab within a tab group,
displaying said tab group's associated bookmark folder, bookmarks and auxiliary applications within the web browser interface;
setting the default bookmark folder or location of said web browser to said tab group's associated bookmark folder or location.

5. Upon changing the active tab of said web browser from a tab within a tab group to an ungrouped tab,
removing said tab group's associated bookmark folder, bookmarks and auxiliary applications from said web browser interface.

6. Upon a user signal to expand a tab group from a collapsed state,
setting the active tab of said web browser to the last active tab of said tab group.

7. Upon a user signal with a mouse click, finger tap or finger swipe on a universal resource locator (URL) displayed within the active tab of the active tab group,
creating a bookmark for said URL in said tab group's associated bookmark folder or opening said URL as a tab within said tab group;
removing said bookmark when the user signals to open said bookmark as a tab.

8. Upon a user signal to save a tab within a tab group,
creating a bookmark with said tab's URL and storing said bookmark in said tab group's associated bookmark folder.

9. Upon a user inputting a search query into said web browser's omnibox
displaying tab groups and bookmark folders that match said search query.

10. Methods of claim 9, further comprising, upon said user selecting the desired tab group or bookmark folder,
opening said tab group;
creating a tab group for the said bookmark folder;
moving the active tab to said tab group;
saving a bookmark with the active tab's URL to said tab group or said bookmark folder.

11. Upon a single user action, closing all open tab groups and removing said tab groups and associated elements from the interface of said web browser.
